(19) United States
(12) Patent Application Publication
(10) Pub. No.: US 2014/0025382 A1
(43) Pub. Date: Jan. 23, 2014

(54) SPEECH PROCESSING SYSTEM

(71) Applicant: KABUSHIKI KAISHA TOSHIBA, Minato-ku (JP)

(72) Inventors: Langzhou CHEN, Cambridge (GB); Mark John Francis Gales, Cambridge (GB); Katherine Mary Knill, Cambridge (GB); Akamine Masami, Cambridge (GB)

(21) Appl. No.: 13/941,968

(22) Filed: Jul. 15, 2013

(30) Foreign Application Priority Data
Jul. 18, 2012 (GB) 1212783.3

(51) Int. Cl. G10L 13/02

(52) U.S. Cl. CPC G10L 13/02
USPC 704/260

(57) ABSTRACT

A text to speech method, the method comprising:
receiving input text;
dividing said inputted text into a sequence of acoustic units;
converting said sequence of acoustic units to a sequence of speech vectors using an acoustic model, wherein said model has a plurality of model parameters describing probability distributions which relate an acoustic unit to a speech vector; and
outputting said sequence of speech vectors as audio,
the method further comprising determining at least some of said model parameters by:
   extracting expressive features from said input text to form an expressive linguistic feature vector constructed in a first space; and
   mapping said expressive linguistic feature vector to an expressive synthesis feature vector which is constructed in a second space.

### FIELD

Embodiments of the present invention as generally described herein relate to speech processing systems and methods.

### BACKGROUND

Speech processing systems generally fall into two main groups: text to speech systems; and speech recognition systems.

Text to speech systems are systems where audio speech or audio speech files are outputted in response to reception of a text file. Text to speech systems are used in a wide variety of applications such as electronic games, E-book readers, E-mail readers, satellite navigation, automated telephone systems, automated warning systems.

There is a need for such systems to be able to output speech with some level of expression. However, current methods for achieving this require supervision or tagging of emotions by a human operator.

### BRIEF DESCRIPTION OF THE FIGURES

Systems and Methods in accordance with non-limiting embodiments will now be described with reference to the accompanying figures in which:

FIG. 1 is schematic of a text to speech system;

FIG. 2 is a flow diagram showing the steps performed by a known speech processing system;

FIG. 3 is a schematic of a Gaussian probability function;

FIG. 4 is a schematic of a synthesis method in accordance with an embodiment;

FIG. 5 is a schematic of a training method in accordance with an embodiment of the present invention;

FIG. 6 is a schematic to show a parallel system for extracting an expressive feature vector from multiple levels of information;

FIG. 7 is a schematic to show a hierarchical system for extracting an expressive feature vector from multiple levels of information;

FIG. 8 is a schematic of a summation used in a CAT method;

FIG. 9 is a schematic of a CAT based system for extracting a synthesis vector;

FIG. 10 is a schematic of a synthesis method in accordance with an embodiment;

FIG. 11 is a schematic of a transform block and input vector for use with a method in accordance with an embodiment;

FIG. 12 is a flow chart showing a training process for training a CAT based system; and

FIG. 13 is a figure showing how decision trees are built to cluster parameters for a CAT based method.

### DETAILED DESCRIPTION

In an embodiment a text to speech method is provided, the method comprising:
receiving input text;
dividing said inputted text into a sequence of acoustic units;
converting said sequence of acoustic units to a sequence of speech vectors using an acoustic model, wherein said model has a plurality of model parameters describing probability distributions which relate an acoustic unit to a speech vector; and
outputting said sequence of speech vectors as audio,
the method further comprising determining at least some of said model parameters by:
extracting expressive features from said input text to form an expressive linguistic feature vector constructed in a first space; and
mapping said expressive linguistic feature vector to an expressive synthesis feature vector which is constructed in a second space.

In an embodiment, mapping the expressive linguistic feature vector to an expressive synthesis feature vector comprises using a machine learning algorithm, for example, a neural network.

The second space may be a multi-dimensional continuous space. This allows a smooth change of expression in the outputted audio.

In an embodiment, extracting the expressive features from said input text comprises a plurality of extraction processes, said plurality of extraction processes being performed at different information levels of said text. For example, the different information levels are selected from a word based linguistic feature extraction level to generate word based linguistic feature, a full context phone based linguistic feature extraction level to generate full context phone based linguistic feature, a part of speech (POS) based linguistic feature extraction level to generate POS based feature and a narration style based linguistic feature extraction level to generate narration style information.

In one embodiment, where expressive features are extracted from multiple information levels, each of the plurality of extraction processes produces a feature vector, the method further comprising concatenating the linguistic feature vectors generated from the different information levels to produce a linguistic feature vector to map to the second space.

In a further embodiment, where expressive features are extracted from multiple information levels, mapping the expressive linguistic feature vector to an expressive synthesis feature vector comprises a plurality of hierarchical stages corresponding to each of the different information levels.

In one embodiment, mapping from the first space to the second space uses full context information. In a further embodiment, the acoustic model receives full context information from the input text and this information is combined with the model parameters derived from the expressive synthesis feature vector in the acoustic model.

In a further embodiment, full context information is used both in the mapping step and is also received as an input to the acoustic model separate from the mapping step.
In some embodiments, the model parameters of said acoustic model are expressed as the weighted sum of model parameters of the same type and the weights are represented in the second space. For example, the model parameters are expressed as the weighted sum of the means of Gaussians. In a further embodiment, the parameters are clustered and the synthesis feature vector comprises a weight for each cluster.

Each cluster may comprise at least one decision tree, said decision tree being based on questions relating to at least one of linguistic, phonetic or prosodic differences. Also, there may be differences in the structure between the decision trees of the clusters.

In some embodiments, a method of training a text-to-speech system is provided, the method comprising:
receiving training data, said training data comprising text data and speech data corresponding to the text data;
extracting expressive features from said input text to form an expressive linguistic feature vector constructed in a first space;
extracting expressive features from the speech data and forming an expressive feature synthesis vector constructed in a second space;
training machine learning algorithm, the training input of the machine learning algorithm being an expressive linguistic feature vector and the training output the expressive feature synthesis vector which corresponds to the training input.

In an embodiment, the machine learning algorithm is a neural network.
The method may further comprise outputting the expressive synthesis feature vector to a speech synthesizer, said speech synthesizer comprising an acoustic model, wherein said model has a plurality of model parameters describing probability distributions which relate an acoustic unit to a speech vector. In such an arrangement, the parameters of the acoustic model and the machine learning algorithm such as a neural network are jointly trained. For example, the model parameters of said acoustic model may be expressed as the weighted sum of model parameters of the same type and the weights are represented in the second space. In such an arrangement, the weights represented in the second space and the neural net may be jointly trained.

In some embodiments, a text to speech apparatus is provided, the apparatus comprising:
a receiver for receiving input text;
a processor adapted to:
   divide said inputted text into a sequence of acoustic units; and
   convert said sequence of acoustic units to a sequence of speech vectors using an acoustic model, wherein said model has a plurality of model parameters describing probability distributions which relate an acoustic unit to a speech vector; and
an audio output adapted to output said sequence of speech vectors as audio,
the processor being further adapted to determine at least some of said model parameters by:
   extracting expressive features from said input text to form an expressive linguistic feature vector constructed in a first space; and
   mapping said expressive linguistic feature vector to an expressive synthesis feature vector which is constructed in a second space.

Since some methods in accordance with embodiments can be implemented by software, some embodiments encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal.

First, systems in accordance with embodiments of the present invention will be explained which relate to text-to-speech systems will be explained.

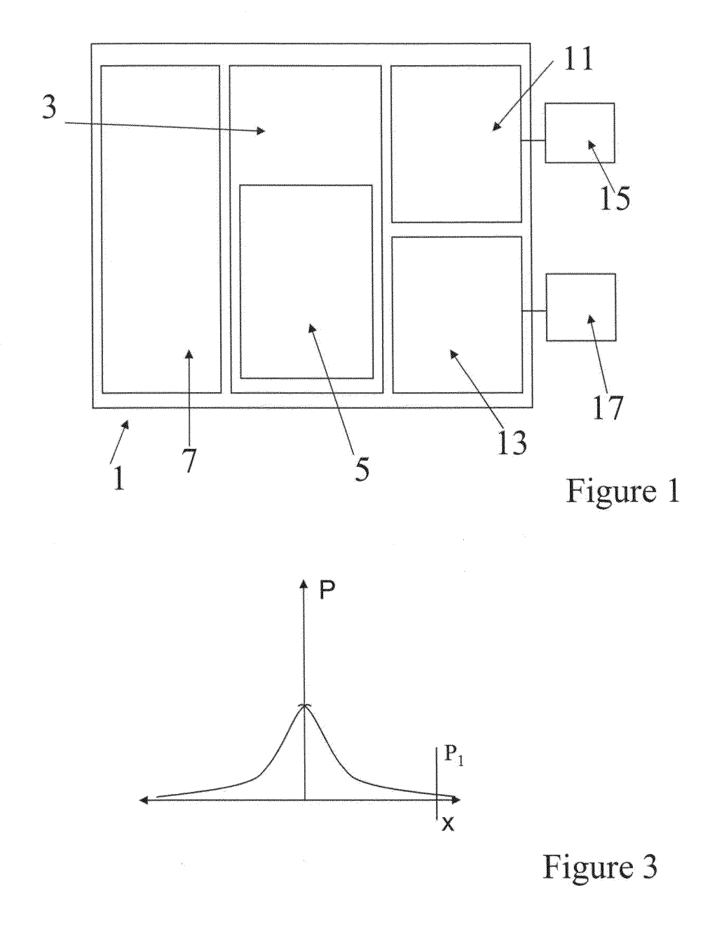

FIG. 1 shows a text to speech system 1. The text to speech system 1 comprises a processor 3 which executes a program 5. Text to speech system 1 further comprises storage 7. The storage 7 stores data which is used by program 5 to convert text to speech. The text to speech system 1 further comprises an input module 11 and an output module 13. The input module 11 is connected to a text input 15. Text input 15 receives text. The text input 15 may be for example a keyboard. Alternatively, text input 15 may be a means for receiving text data from an external storage medium or a network.

Connected to the output module 13 is output for audio 17. The audio output 17 is used for outputting a speech signal converted from text which is input into text input 15. The audio output 17 may be for example a direct audio output e.g. a speaker or an output for an audio data file which may be sent to a storage medium, networked etc.

In use, the text to speech system 1 receives text through text input 15. The program 5 executed on processor 3 converts the text into speech data using data stored in the storage 7. The speech is output via the output module 13 to audio output 17.

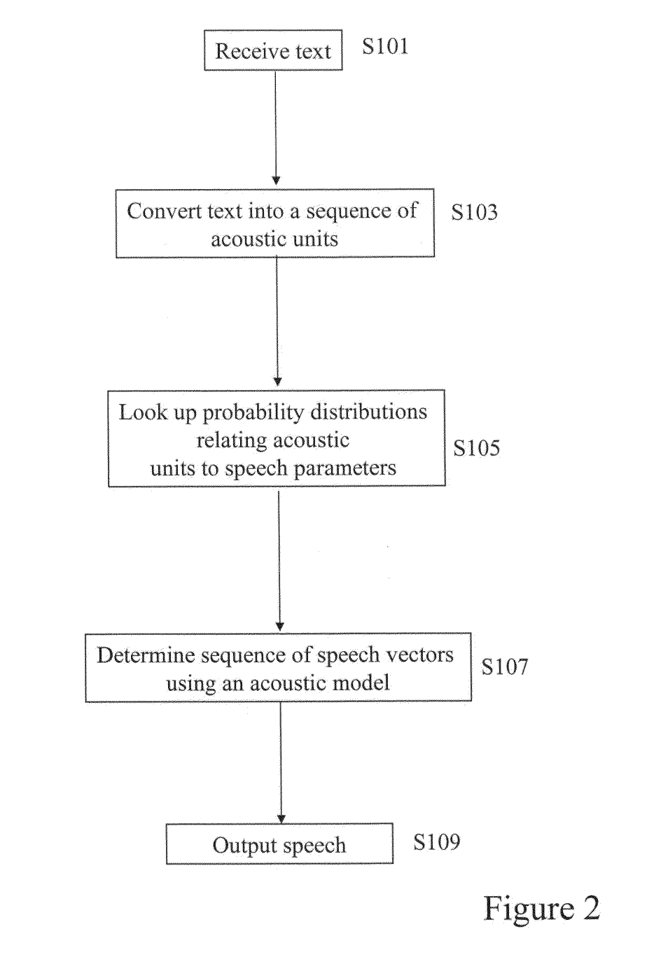

A simplified process will now be described with reference to FIG. 2. In first step, S101, text is inputted. The text may be inputted via a keyboard, touch screen, text predictor or the like. The text is then converted into a sequence of acoustic units. These acoustic units may be phonemes or graphemes. The units may be context dependent e.g. triphones which take into account not only the phoneme which has been selected but the proceeding and following phonemes. The text is converted into the sequence of acoustic units using techniques which are well-known in the art and will not be explained further here.

In step S105, the probability distributions are looked up which relate acoustic units to speech parameters. In this embodiment, the probability distributions will be Gaussian distributions which are defined by means and variances. Although it is possible to use other distributions such as the Poisson, Student-t, Laplacian or Gamma distributions some of which are defined by variables other than the mean and variance.

It is impossible for each acoustic unit to have a definitive one-to-one correspondence to a speech vector or “observation” to use the terminology of the art. Many acoustic units are pronounced in a similar manner, are affected by surrounding acoustic units, their location in a word or sentence, or are pronounced differently by different speakers or expressions. Thus, each acoustic unit only has a probability of being related to a speech vector and text-to-speech systems calculate many probabilities and choose the most likely sequence of observations given a sequence of acoustic units.

A Gaussian distribution is shown in FIG. 3. FIG. 3 can be thought of as being the probability distribution of an acoustic unit relating to a speech vector. For example, the speech vector shown as X has a probability P1 of corresponding to the phoneme or other acoustic unit which has the distribution shown in FIG. 3.

The shape and position of the Gaussian is defined by its mean and variance. These parameters are determined during the training of the system.

These parameters are then used in the acoustic model in step S107. In this description, the acoustic model is a Hidden Markov Model (HMM). However, other models could also be used.

The text of the speech system will store many probability density functions relating an to acoustic unit i.e. phoneme, grapheme, word or part thereof to speech parameters. As the Gaussian distribution is generally used, these are generally referred to as Gaussians or components.

In a Hidden Markov Model or other type of acoustic model, the probability of all potential speech vectors relating to a specific acoustic unit must be considered. Then the sequence of speech vectors which most likely corresponds to the sequence of acoustic units will be taken into account. This implies a global optimization over all the acoustic units of the sequence taking into account the way in which two units affect to each other. As a result, it is possible that the most likely speech vector for a specific acoustic unit is not the best speech vector when a sequence of acoustic units is considered.

Once a sequence of speech vectors has been determined, speech is output in step S109.

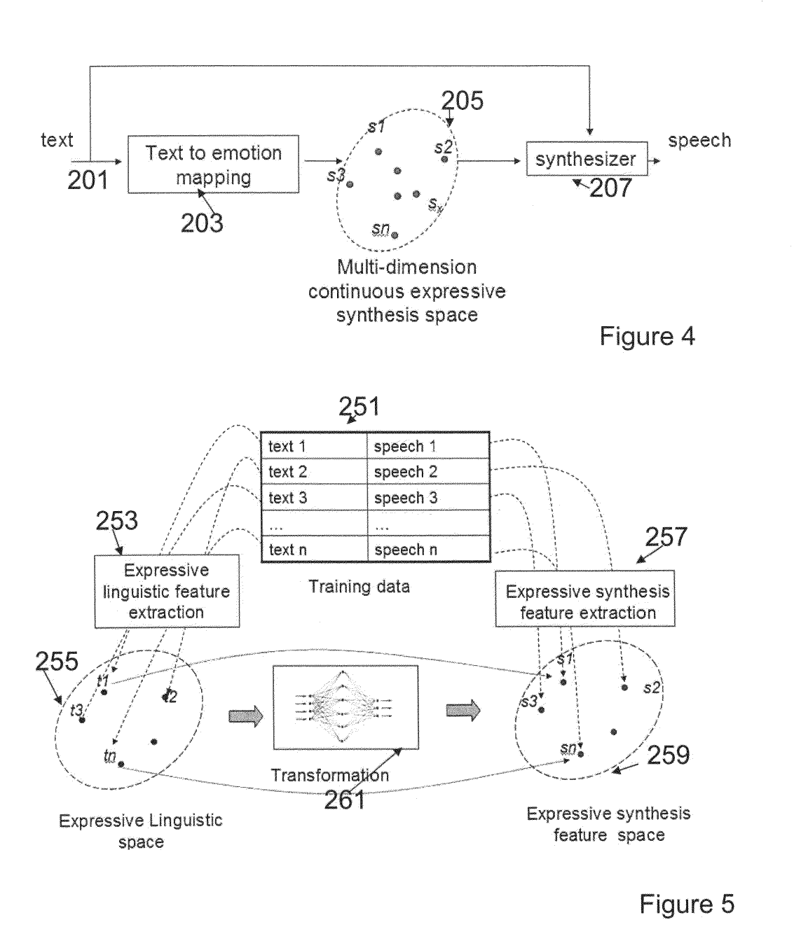

FIG. 4 is a schematic of a text-to-speech system in accordance with an embodiment of the present invention.

Text is input at text input 201. Next, in section 203, expressive features are extracted from the input text. For example, a human reader of the text would know whether the text should be read with an anxious voice, happy voice etc from the text itself. The system also derives this information from the text itself without requiring human interaction to indicate how the text should be outputted.

How this information is automatically collected will be described in more detail later. However, the output is a feature vector with numerical values located in a first multi-dimensional space. This is then mapped to a, second, continuous multi-dimension expressive synthesis space 205. Values in the second continuous multi-dimension space can be used directly to modify an acoustic model in synthesizer 207. The synthesizer 207 also receives the text as an input.

In methods in accordance with embodiments expressive TTS is viewed as a process to map the text data to a point in a multi-dimension continuous space. In this multi-dimension continuous space, each point represents particular expressive information which is related to the synthesis process directly.

A multi-dimension continuous space contains infinite number of points; therefore the proposed method can potentially deal with infinite number of different types of emotions and synthesize the speech with much richer expressive information.

First, the training of methods and systems in accordance with embodiments of the invention will be described.

The training will be described with reference to FIG. 5. Training data 251 is provided with text and speech corresponding to the text input.

It is assumed that each utterance in the training data 251 contains unique expressive information. This unique expressive information can be determined from the speech data and can be read from the transcription of the speech, i.e. the text data as well. In the training data, the speech sentences and text sentences are synchronized as shown in FIG. 5.

An “expressive linguistic feature extraction” block 253 is provided which converts each text sentence in the training data into a vector which will be termed an expressive linguistic feature vector.

Any text sentences can be converted as a linguistic feature through expressive linguistic feature extraction block 253, and all the possible expressive linguistic features construct a first space 255 which will be called an expressive linguistic space. Each transcription of the training sentence can be viewed as a point in this expressive linguistic space. The expressive linguistic feature vector should catch the emotion information in text sentences.

During training, as well as extracting expressive linguistic features from the text, an “expressive synthesis feature extraction” block 257 is provided which converts each speech sentence into a vector which will be called an expressive synthesis feature vector.

Any speech sentences can be converted as an expressive synthesis feature through “expressive synthesis feature extraction” block 257, and all the possible expressive synthesis features construct an expressive synthesis space 259. The requirement to the expressive synthesis feature is that it should catch the unique expressive information of original speech sentence; meanwhile, this expressive information can be re-generated in the synthesis process.

Given the linguistic features from transcription of training data and the synthesis features from training speech sentences, methods and systems in accordance with embodiments of the present invention train a transformation 261 to transform a linguistic feature vector in linguistic feature space 255 to a synthesis feature vector in synthesis feature space 259.

In the synthesis stage, the “expressive linguistic feature extraction” block 253 converts the text to be synthesized into a linguistic feature vector in linguistic feature space 255, then through the transformation block 261, the linguistic feature is mapped to a synthesis feature in expressive synthesis space 259. This synthesis feature vector contains the emotion information in original text data and can be used by the synthesizer 207 (FIG. 4) directly to synthesize the expressive speech.

In an embodiment, machine learning methods, e.g. neural network (NN) are used to provide the transformation block 261 and train the transformations from expressive linguistic space 255 to expressive synthesis space 259. For each sentence in the training data 251, the speech data is used to generate an expressive synthesis feature vector in synthesis feature space 259 and the transcription of the speech data is used to generate an expressive linguistic feature in linguistic feature space 255. Using the linguistic features of the training data as the input of NN and the synthesis features of the training data as the target output, the parameters of the NN can be updated to learn the mapping from linguistic feature space to synthesis feature space.

The “linguistic feature extraction” block 253 converts the text data into a linguistic feature vector. This feature vector should contain the discriminative information, i.e. if two text data contains different emotion, their linguistic features should be distinguishable in the linguistic features space.

In one embodiment, Bag-of-word (BoW) technologies are be used to generate the linguistic feature. BoW methods express the text data as vector of word frequencies. The dimension of the vector is equal to the size of vocabulary and each element contains the frequency of a particular word in vocabulary. Different well-developed BoW technologies can be applied, e.g. latent semantic analysis (LSA), probabilistic latent semantic analysis (pLSA), latent Dirichlet allocation (LDA) etc. Through these technologies, the original word frequency vector whose dimension is equal to vocabulary size can be compacted in very low dimension.

In a further embodiment, in order to model the emotion information in text data more accurately, different levels of knowledge from the text data are used to generate the linguistic features.

In one embodiment, not only the word level information, but also the lower level information such as full context phone sequence and the higher level information such as part-of-speech (POS), narration styles are to be used to generate the linguistic features.

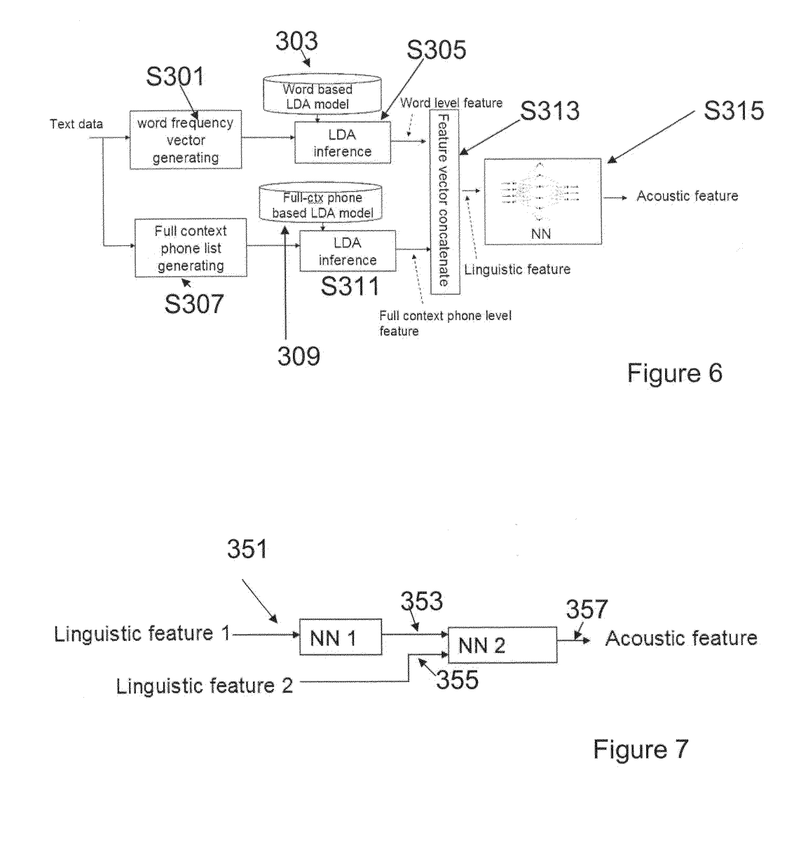

To combine the information from the different levels together, in one embodiment, a parallel structure is used as shown in FIG. 6. In the parallel structure, the features in different levels are extracted separately, and then the features in different levels are concatenated to one big vector to be the input for the transformation block.

FIG. 6 illustrates a parallel structure for extracting linguistic features which may be used in a system in accordance with an embodiment. Text data are converted into a word frequency vector in step S301. Next, an LDA model 303 with words as units is used at step S305 to convert the word frequency vector into a word level feature vector. In step S305, variantial posterior dirichlet parameters are estimated through an inference process.

At the same time, text data is converted as a sequence of full context phones in step S307. This full context phone sequence is converted into a full context phone level feature vector in S311 using a LDA model 309 with full context phones as units.

Then the word level feature vector and the full context phone level feature vector are concatenated as linguistic features to form the linguistic feature vector in S313.

FIG. 6 is used to show an example of how to extract linguistic features. In further embodiments, higher level knowledge such as POS, narration style and any other useful information from text data can be integrated into linguistic feature.

Further, BoW methods other than LDA can be used to extract linguistic feature as well.

Linguistic features determined from different levels of information can also be combined using a hierarchical structure as well. In one embodiment of such a hierarchical structure, linguistic features with different levels of knowledge are incorporated into the system with a cascade of NNs, as shown in FIG. 7.

In FIG. 11, the linguistic feature 1 and linguistic feature 2 represent linguistic features determined from different levels of knowledge, e.g. word level feature, full context phone level feature etc.

Feature 1 is used as input 351 of NN1. Then, the output 353 of NN1 is combined with feature 2 as input 355 of NN2 to generate the acoustic feature at output 357.

Returning to FIG. 5, the expressive synthesis feature extraction block 257 is used to represent the expressive information of the speech data. Each point in the expressive synthesis feature space 259 represents unique expressive information in speech.

In methods and systems in accordance with embodiments of the present invention, the expressive synthesis features satisfy two requirements:

Requirement 1—given the speech data, the associated synthesis feature must capture the expressive information of this speech data.

Requirement 2—the expressive information recorded in the expressive synthesis feature must be used in the synthesis stage to generate the speech with same expressiveness, i.e. the synthesis feature determines the synthesis parameters.

A basis related to the synthesis parameters can be built. Then, the synthesis parameters for each particular degree of expressiveness can be projected onto this basis. This defines the representation of expressive synthesis parameters in terms of their coordinates in this projection.

In one embodiment, cluster adaptive training (CAT) is used. Here, cluster HMM models are defined as the basis and the expressiveness dependent HMM parameters are projected onto this basis (please see the appendix).

This allows expressiveness dependent HMM parameters to be represented as the linear interpolation of cluster models and the interpolation weights for each cluster HMM model are used to represent the expressiveness information.

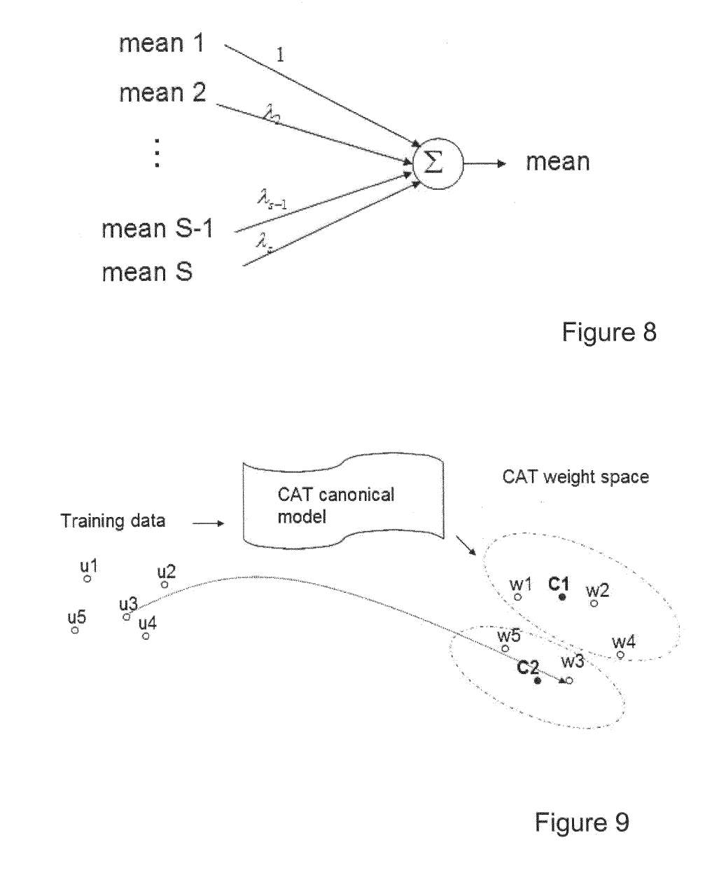

As shown in FIG. 8, CAT model contains a bias cluster HMM model and P−1 non-bias cluster HMM models. For a particular Gaussian component, the variance and the prior are assumed to be the same across all clusters, while the mean parameters are determined by a linear interpolation of all the cluster means.

Given an observation vector, the probability density function of component m can be expressed as:

$$p ( {o}_{t} \vert {Λ}^{( e )} , {M}^{( m )} , {\sum }^{( m )} ) = N ( {o}_{t} ; {μ}^{( m , l )} + {\sum }_{p = 2}^{P} {λ}^{( e , p )} {μ}^{( m , p )} m {\sum }^{( m )} )$$

Where M^{(m)}=[μ^{(m,1)} μ^{(m,2)} μ^{(m,P)}] is the matrix of mean vectors of component m from different cluster models and Σ^{(m)} is the variance of component m which is shared by all the clusters.

Λ^{(e)}=[1λ(^{e,2})λ^{(e,P)}] is the CAT weight vector for emotion e. Cluster 1 is the bias model and the CAT weight for the bias model is fixed as 1.

When the CAT model is used to do the expressive speech synthesis, the emotion dependent information is recorded in the CAT weight. In the training process, using the emotion dependent training data, the emotion dependent CAT weights are trained by maximum likelihood criterion. In the synthesis stage, emotion dependent CAT weights are used to synthesize the speech with particular emotion.

The CAT weight is suitable to be used as the expressive synthesis feature vector in the proposed method. It satisfies two requirements mentioned above to the synthesis features, i.e. it contains the emotion information of the speech data and the CAT weight for a certain emotion can be used to synthesize the speech with same emotion. The CAT weight space which contains all the possible CAT weight can be use as synthesis feature space in proposed method. Given the CAT canonical models (i.e. bias HMM model and cluster HMM models), each training sentence can be expressed as a point in CAT weight space by maximizing the likelihood of this speech sentence. The concept of CAT weight space is shown in FIG. 9.

In CAT weight space, each training sentence can be expressed as a point which contains the unique emotion information for this sentence. If there are N sentences in the training data, in CAT weight space, N points may be used to represent the training data. Furthermore, it can be assumed that training sentences which are close to each other in CAT space contain similar emotion information.

Therefore, the training data can be classified into groups and the group dependent CAT weights can be estimated using all the training sentences in this group. If N training sentences are classified into M groups (M<<N), the training data can be expressed as M points in the CAT weight space.

In an embodiment, the NN used as transformation to map the linguistic features into the synthesis features and the CAT model which is used to construct the expressive synthesis feature space, can be trained jointly. The joint training process can be described as follows

1. Initial CAT model training to generate initial canonical model M0 and the initial CAT weight set Λ₀ which is composed of the CAT weights for all the training sentences, set iteration number i=0
2. Given the expressive linguistic features of training sentences and the CAT weight set of training sentences Λᵢ, the NN for iteration i, i.e. NNᵢ is trained using least square error criterion.
3. Using the expressive linguistic features of training sentences as input, NNᵢ generate output CAT weight set of training sentences Oᵢ
4. Λᵢ₊₁=Oᵢ. Given Λᵢ₊₁ re-train the CAT canonical model Mᵢ₊₁, to maximize the likelihood of training data
5. i=i+1 if algorithm converged, goto 6, else go to 2
6. end

Through the process mentioned above, the NN and the CAT model are updated jointly which can improve performance at the synthesis stage.

This joint training process is not limited to NN and CAT models. In general a transformation from linguistic feature space to synthesis feature space other than NN and the methods to construct the synthesis feature space other than CAT can be updated using joint training in the same framework.

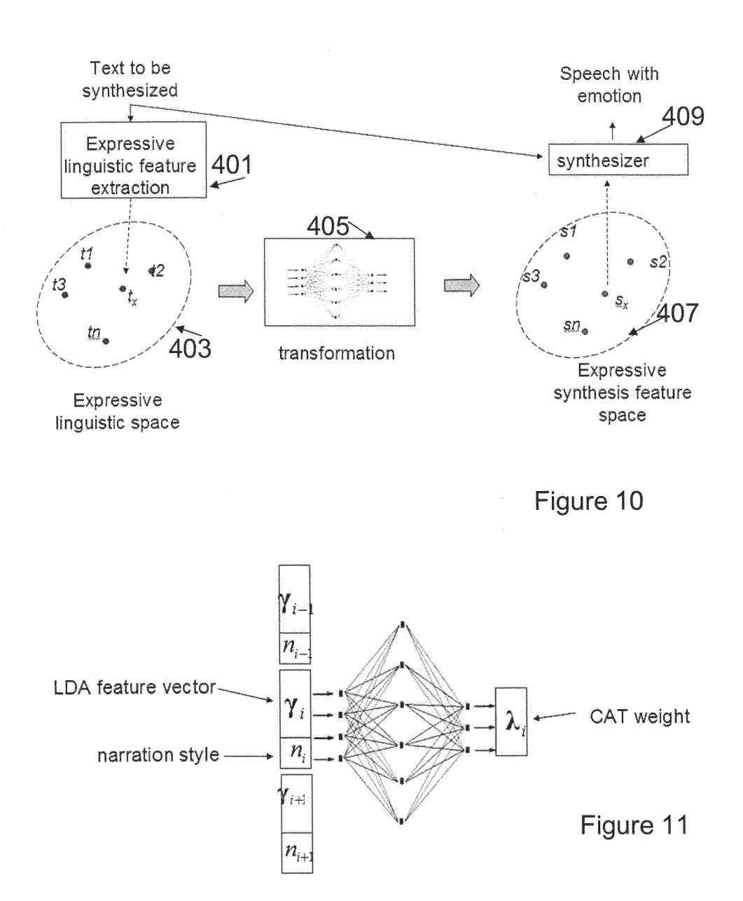

The above has described the training for the system. The text to speech synthesis will now be described with reference to FIG. 10.

The synthesis system shown in FIG. 10 comprises an expressive linguistic feature extraction block 401 which extracts an expressive feature vector in an expressive linguistic space 403 as described with reference to the training. The process for extracting this vector in the synthesis stage is identical to the process described in the training stage.

The expressive feature vector is then mapped via transformation block 405 to an expressive synthesis vector in an expressive synthesis space 407. The transformation block 405 has been trained as described above.

The determined expressive synthesis vector is then used directly in the synthesis of the output speech as synthesizer 409. As described above, in one embodiment the transformation block 405 maps the expressive linguistic feature vector directly to CAT weights in the expressive synthesis feature space 407.

In one embodiment, the text to be synthesized is also sent directly to the synthesizer 409. In this arrangement, the synthesizer 409 receives the text to synthesized in order to determine context dependent information. In other embodiments, the mapping from the expressive linguistic space to the expressive synthesis feature space may use context dependent information. This may be in addition to or instead of the information being received directly by the synthesizer.

In a method in accordance with an embodiment, there is no need to prepare special training data or require human interaction to assess training data. Further, the text to be synthesized is converted into the linguistic feature vector directly. This linguistic feature vector contains much more emotion information than a single emotion ID. The transformation block converts a linguistic feature vector into an expressive synthesis feature with same emotion. Further, this synthesis feature can be used to synthesize the speech with same emotion as in original text data.

If in expressive synthesis feature space, each training sentence is related to a unique synthesis feature vector, the unique emotion information in each sentence is learned by the transformation, e.g. NN. It can provide the user with very rich emotion resources for synthesis.

The training sentences when in the synthesis feature space can be classified into groups and all the training sentences in one group share the emotion information. Through this way, the training of transformation is improved since the number of patterns which need to be learnt is reduced. Therefore the transformation being estimated can be more robust. Choosing a sentence based synthesis feature or group based synthesis feature, tuning the number of groups for training data, may achieve a balance between the expressiveness and robustness for synthesis performance more easily in methods in accordance with embodiments of the invention.

In the above method, hard decision emotion recognition can be avoided and this will reduce errors. The possible outputs of a NN are infinite. It means that the proposed method potentially can generate infinite different synthesis features which are related to different emotions for synthesis. Further, the above method can achieve the balance between expressiveness and robustness easily.

In the above synthesis process, the emotion information of the text data does not need to be known or explicitly recognized by a human or from other sources. The training is completely automatic. The above method aims at building an expressive synthesis system without the need for a human to tag training data with emotions. During the synthesis process, there is no need for any classification of the emotions attributed to the input text. The proposed method can potentially reduce the cost of the training of expressive synthesis system. Meanwhile generate more expressive speech in synthesis process.

In the above embodiment, a multi-dimensional continuous expressive speech synthesis space is defined such that every point in the space defines parameters for an expressive speech synthesis system. Also, a mapping process is trained which can map text features to a point in expressive space which then defines parameters for an expressive speech synthesis process.

To illustrate the synthesis method, an experimental system for expressive synthesis was trained based on 4.8 k training sentence. A CAT model with one bias model and 4 cluster models was trained. An individual CAT weight was trained for each sentence in training speech. Meanwhile, the training data were classified into 20 groups, the group based CAT weights were trained as well. Both the sentence based CAT weights and group based CAT weights were expressed as the points in same CAT weight space, i.e. the acoustic space in the proposed method.

Each sentence of the transcription of the training speech was expressed as a 20-dimension LDA variational posterior feature vector, and it was used to construct the linguistic features. The narration style of the training sentence was also used to construct the linguistic feature. It was a 1-dimension value to indicate the sentence was direct speech, narration speech or carrier speech. The linguistic features used in this experiment also included the linguistic information from previous sentence and last sentence. In this experiment, the linguistic features were constructed using parallel structure.

The non-linear transformation from linguistic space to acoustic space was trained by multilayer perception (MLP) neural network. 2 sets of NN were trained, one was mapping the linguistic features to the sentence based CAT weights, the other was mapping the linguistic features to the group based CAT weights.

The structure of the linguistic features and acoustic features used in this experiment is shown in FIG. 11.

The expressiveness of the synthesized speech was evaluated by listening test via CrowdFlower. Using the original expressive speech data read by human as reference, the listeners were asked to choose which of 2 synthesized versions of speech sentences sounded more similar to the reference.

Five different systems were compared in the experiments.

1. sup_sent: the sentence based CAT weight generated by supervised training
2. sup_grp: the group based CAT weight generated by supervised training
3. nn_sent: the sentence based CAT weight generated by proposed method
4. nn_grp: the group based CAT weight generated by proposed method
5. rand: the CAT weight randomly selected from training sentence.

The expressiveness test results were shown in Table 1

| sup_grp | sup_sent | nn_grp | nn_sent | rand | P value |
|---|---|---|---|---|---|
| 52.3 | | 47.7 | | | 0.107 |
| | 63.9 | | 36.1 | | <0.001 |
| | | 55.0 | 45.0 | | 0.004 |
| | | 61.8 | | 38.2 | <0.001 |
| | | | 57.2 | 42.8 | <0.001 |

The experimental results indicated that based on the proposed method both sentence based CAT weights and group based CAT weight outperformed the random CAT weight significantly. It means that proposed method partially caught the correct emotion information in the sentences. Meanwhile, for the group based CAT weight, the difference between supervised trained CAT weights and the CAT weights generated by proposed method was not significant (p>0.025). This means that in the case of group based CAT weight, the performance of the proposed method is close to their upper boundary, i.e. the supervised training.

### Appendix

In some embodiments, the expressive synthesis feature space contains weightings for components to be used in the synthesis of speech.

In some embodiments, there will be a plurality of different states which will be each be modelled using a Gaussian. For example, in an embodiment, the text-to-speech system comprises multiple streams. Such streams may be selected from one or more of spectral parameters (Spectrum), Log of fundamental frequency (Log F₀), first differential of Log F₀ (Delta Log Fₒ), second differential of Log F₀ (Delta-Delta Log Fₒ), Band aperiodicity parameters (BAP), duration etc. The streams may also be further divided into classes such as silence (sil), short pause (pau) and speech (spe) etc. In an embodiment, the data from each of the streams and classes will be modelled using a HMM. The HMM may comprise different numbers of states, for example, in an embodiment, 5 state HMMs may be used to model the data from some of the above streams and classes. A Gaussian component is determined for each HMM state.

The mean of a Gaussian with a particular expressive characteristic is expressed as a weighted sum of expressive characteristic independent means of the Gaussians. Thus:

$${μ}_{m}^{( s )} = {\sum }_{i}^{ } {λ}_{i , q ( m )}^{( s )} {μ}_{c ( m , i )} \qquad Eqn . 1$$

where μₘ^{(s)} is the mean of component m in with an expressive characteristic s, iε{1, . . . , P} is the index for a cluster with P the total number of clusters, λ_{i,q(m)}^{(s)} is the expressive characteristic dependent interpolation weight of the i^{th} cluster for the expressive characteristic s and regression class q(m); μ_{c(m,i)} is the mean for component m in cluster i. In one embodiment, one of the clusters, usually cluster i=1, all the weights are always set to 1.0. This cluster is called the ‘bias cluster’. Each cluster comprises at least one decision tree. There will be a decision tree for each component in the cluster. In order to simplify the expression, c(m,i)ε{1, . . . , N} indicates the general leaf node index for the component m in the mean vectors decision tree for cluster i^{th}, with N the total number of leaf nodes across the decision trees of all the clusters. The details of the decision trees will be explained later.

In an embodiment using CAT, the expressive synthesis space is a space of the expressive characteristic weightings and the expressive linguistic space maps to the expressive synthesis space.

The expression characteristic independent means are clustered. In an embodiment, each cluster comprises at least one decision tree, the decisions used in said trees are based on linguistic, phonetic and prosodic variations. In an embodiment, there is a decision tree for each component which is a member of a cluster. Prosodic, phonetic, and linguistic contexts affect the final speech waveform. Phonetic contexts typically affects vocal tract, and prosodic (e.g. syllable) and linguistic (e.g., part of speech of words) contexts affects prosody such as duration (rhythm) and fundamental frequency (tone). Each cluster may comprise one or more sub-clusters where each sub-cluster comprises at least one of the said decision trees.

The following configuration may be used in accordance with an embodiment of the present invention. To model this data, in this embodiment, 5 state HMMs are used. The data is separated into three classes for this example: silence, short pause, and speech. In this particular embodiment, the allocation of decision trees and weights per sub-cluster are as follows.

In this particular embodiment the following streams are used per cluster:

Spectrum: 1 stream, 5 states, 1 tree per state×3 classes
LogF0: 3 streams, 5 states per stream, 1 tree per state and stream×3 classes
BAP: 1 stream, 5 states, 1 tree per state×3 classes
Duration: 1 stream, 5 states, 1 tree×3 classes (each tree is shared across all states)
Total: 3×26=78 decision trees

For the above, the following weights are applied to each stream per voice characteristic e.g. speaker or expression:

Spectrum: 1 stream, 5 states, 1 weight per stream×3 classes
LogF0: 3 streams, 5 states per stream, 1 weight per stream×3 classes
BAP: 1 stream, 5 states, 1 weight per stream×3 classes
Duration: 1 stream, 5 states, 1 weight per state and stream×3 classes
Total: 3×10=30 weights

As shown in this example, it is possible to allocate the same weight to different decision trees (spectrum) or more than one weight to the same decision tree (duration) or any other combination. As used herein, decision trees to which the same weighting is to be applied are considered to form a sub-cluster.

Next, how to derive the expression characteristic weights will be described. In speech processing systems which are based on Hidden Markov Models (HMMs), the HMM is often expressed as:

M=(A,B,Π) Eqn. 2

where A={aᵢⱼ}_{i,j=1}^{N} and is the state transition probability distribution, B={bⱼ(o)}ⱼ₌₁^{N} is the state output probability distribution and Π={πᵢ}ᵢ₌₁^{N} is the initial state probability distribution and where N is the number of states in the HMM.

How a HMM is used in a text-to-speech system is well known in the art and will not be described here.

In the current embodiment, the state transition probability distribution A and the initial state probability distribution are determined in accordance with procedures well known in the art. Therefore, the remainder of this description will be concerned with the state output probability distribution.

Generally in expressive text to speech systems the state output vector or speech vector o(t) from an M^{th} Gaussian component for expressive characteristic s in a model set M is

P(o(t)|m,s,M)=N(o(t);μₘ^{(s)},Σₘ^{(s)}) Eqn. 3

where μ^{(s)}ₘ and Σ^{(s)}ₘ are the mean and covariance of the m^{th} Gaussian component for expressive characteristic s.

The aim when training a conventional text-to-speech system is to estimate the Model parameter set M which maximises likelihood for a given observation sequence. In the conventional model, there is one single speaker or expression, therefore the model parameter set is μ^{(s)}ₘ=μₘ and Σ^{(s)}ₘ=Σₘ for the all components m.

As it is not possible to obtain the above model set based on so called Maximum Likelihood (ML) criteria purely analytically, the problem is conventionally addressed by using an iterative approach known as the expectation maximisation (EM) algorithm which is often referred to as the Baum-Welch algorithm. Here, an auxiliary function (the “Q” function) is derived:

$$Q ( M , {M}^{′} ) = {\sum }_{ m , t}^{ } {γ}_{m} ( t ) log p ( o ( t ) , m \vert M ) \qquad Eqn 4$$

where γₘ (t) is the posterior probability of component m generating the observation o(t) given the current model parameters M′ and m is the new parameter set. After each iteration, the parameter set M′ is replaced by the new parameter set M which maximises Q(M, M′). p(o(t), m|M) is a generative model such as a GMM, HMM etc. In the present embodiment a HMM is used which has a state output vector of:

P(o(t)|m,s,M)=N(o(t);\hat{μ}ₘ^{(s)},\hat{Σ}ᵥ₍ₘ₎^{(s)}) Eqn. 5

Where mε{1, . . . , MN}, tε{1, . . . , T} and sε{1, . . . , S} are indices for component, time and expressions respectively and where MN, T, and S are the total number of components, frames, and expressions respectively.

The exact form of \hat{μ}ₘ^{(s)} and \hat{Σ}ₘ^{(s)} depends on the type of expression dependent transforms that are applied. In the framework of CAT, the mean vector for component m and expression s \hat{μ}ₘ^{(s)} can be written as equation 1. The covariance \hat{Σ}ₘ^{(s)} is independent to the expression s, i.e. \hat{Σ}ₘ^{(s)}=\hat{Σ}ᵥ₍ₘ₎ where v(m) represents the leaf node of covariance decision tree.

For reasons which will be explained later, in this embodiment, the covariances are clustered and arranged into decision trees where v(m)ε{1, . . . , V} denotes the leaf node in a covariance decision tree to which the co-variance matrix of the component m belongs and V is the total number of variance decision tree leaf nodes.

Using the above, the auxiliary function can be expressed as:

$$Q ( M , {M}^{′} ) = - \frac{1}{2} {\sum }_{m , t , s}^{ } {γ}_{m} ( t ) \{ log \vert {{\sum }^{⋒}}_{v ( m )} \vert + {( o ( t ) - {{μ}^{⋒}}_{m}^{( s )} )}^{T} {\sum }_{v ( m )}^{⋒ - 1} ( o ( t ) - {{μ}^{⋒}}_{m}^{( s )} ) \} + C \qquad Eqn 6$$

where C is a constant independent of M
The parameter estimation of CAT can be divided into 3 parts:
The first part are the parameters of the Gaussian distributions for cluster models, i.e. expression independent means {μₙ} and the expression independent covariance {Σₖ} the above indices n and k indicate leaf nodes of the mean and variance decision trees which will be described later. The second part are the expression dependent weights {λ_{i,q(m)}^{(s)}}_{s,i,m} where s indicates expression, i the cluster index parameter and q(m) the regression class index for component m. The third part are the cluster dependent decision trees.

Once the auxiliary function is expressed in the above manner, it is then maximized with respect to each of the variables in turn in order to obtain the ML values of the expression independent and dependent parameters.

In detail, for determining the ML estimate of the mean, the following procedure is performed.

First, the auxiliary function of equation 4 is differentiated with respect to μₙ as follows:

$$\begin{matrix}\frac{\partial Q ( M ; \hat{M} )}{\partial {μ}_{n}} = {k}_{n} - {G}_{nn} {μ}_{n} - {\sum }_{v \neq n}^{ } {G}_{nv} {μ}_{v} \\ where & Eqn . 7 \\ {G}_{nv} = {\sum }_{{m , i , j}_{{c ( m , i ) = n}_{c ( m , j ) = n}}}^{ } {G}_{ij}^{( m )} , {k}_{n} = {\sum }_{{m , i}_{c ( m , i ) = n}}^{ } {k}_{i}^{( m )} . & Eqn . 8\end{matrix}$$

with Gᵢⱼ^{(m)} and kᵢ^{(m)} accumulated statistics

$${G}_{ij}^{( m )} = {\sum }_{t , s}^{ } {γ}_{m} ( t , s ) {λ}_{i , q ( m )}^{( s )} {\sum }_{v ( m )}^{- 1} {λ}_{j , q ( m )}^{( s )} \\ {k}_{i}^{( m )} = {\sum }_{t , s}^{ } {γ}_{m} ( t , s ) {λ}_{i , q ( m )}^{( s )} {\sum }_{v ( m )}^{- 1} o ( t ) . \qquad Eqn . 9$$

By maximizing the equation in the normal way by setting the derivative to zero, the following formula is achieved for the ML estimate of μₙ i.e. \hat{μ}ₙ:

$${\hat{μ}}_{n} = {G}_{nn}^{- 1} ( {k}_{n} - {\sum }_{v \neq n}^{ } {G}_{nv} {μ}_{v} ) \qquad Eqn . 10$$

It should be noted, that the ML estimate of μₙ also depends on μₖ where k does not equal n. The index n is used to represent leaf nodes of decisions trees of mean vectors, whereas the index k represents leaf modes of covariance decision trees. Therefore, it is necessary to perform the optimization by iterating over all μₙ until convergence.

This can be performed by optimizing all μₙ simultaneously by solving the following equations.

$$[ \begin{matrix}{G}_{11} & … & {G}_{1 N} \\ ⋮ & ⋱ & ⋮ \\ {G}_{N 1} & … & {G}_{NN}\end{matrix} ] [ \begin{matrix}{\hat{μ}}_{1} \\ ⋮ \\ {\hat{μ}}_{N}\end{matrix} ] = [ \begin{matrix}{k}_{1} \\ ⋮ \\ {k}_{N}\end{matrix} ] , \qquad Eqn . 11$$

However, if the training data is small or N is quite large, the coefficient matrix of equation 11 cannot have full rank. This problem can be avoided by using singular value decomposition or other well-known matrix factorization techniques.

The same process is then performed in order to perform an ML estimate of the covariances i.e. the auxiliary function shown in equation (6) is differentiated with respect to Σₖ to give:

$$\begin{matrix}{\sum }_{k}^{\hat{}} = \frac{{\sum }_{v ( m ) = k}^{t , s , m} {γ}_{m} ( t , s ) \overline{o} ( t ) {\overline{o} ( t )}^{T}}{{\sum }_{v ( m ) = k}^{t , s , m} {γ}_{m} ( t , s )} \\ Where & Eqn . 12 \\ \overline{o} ( t ) = o ( t ) - {μ}_{m}^{( s )} & Eqn . 13\end{matrix}$$

The ML estimate for expression dependent weights can also be obtained in the same manner i.e. differentiating the auxiliary function with respect to the parameter for which the ML estimate is required and then setting the value of the differential to 0.

For the expression dependent weights this yields

$${λ}_{q}^{( s )} = {( {\sum }_{{t , m}_{q ( m ) = q}}^{ } {γ}_{m} ( t , s ) {M}_{m}^{T} {\sum }_{ }^{- 1} {M}_{m} )}^{- 1} {\sum }_{{t , m}_{q ( m ) = q}}^{ } {γ}_{m} ( t , s ) {M}_{m}^{T} {\sum }_{ }^{- 1} o ( t ) \qquad Eqn . 14$$

Equation 14 is the CAT weight estimation without the bias cluster, with the bias cluster, the CAT weight estimation can be re-written as

$${λ}_{q}^{( s )} = {( {\sum }_{{t , m}_{q ( m ) = q}}^{ } {γ}_{m} ( t , s ) {M}_{m}^{T} {{\sum }_{v ( m )}}_{ }^{- 1} {M}_{m} )}^{- 1} {\sum }_{{t , m}_{q ( m ) = q}}^{ } {γ}_{m} ( t , s ) {M}_{m}^{T} {{\sum }_{v ( m )}}_{ }^{- 1} ( o ( t ) - {μ}_{c ( m , 1 )} ) \qquad Eqn . 15$$

Where μ_{c(m,1)} is the mean vector of component m for bias cluster model, Mₘ is the matrix of non-bias mean vectors for component m.

The third part of parameter estimation is decision tree construction. The cluster dependent decision trees are constructed cluster by cluster. When the decision tree of a cluster is constructed, the parameters of other clusters, including the tree structures, Gaussian mean vectors and covariance matrices are fixed.

Each binary decision tree is constructed in a locally optimal fashion starting with a single root node representing all contexts. In this embodiment, by context, the following bases are used, phonetic, linguistic and prosodic. As each node is created, the next optimal question about the context is selected. The question is selected on the basis of which question causes the maximum increase in likelihood and the terminal nodes generated in the training examples.

Then, the set of terminal nodes is searched to find the one which can be split using its optimum question to provide the largest increase in the total likelihood to the training data. Providing that this increase exceeds a threshold, the node is divided using the optimal question and two new terminal nodes are created. The process stops when no new terminal nodes can be formed since any further splitting will not exceed the threshold applied to the likelihood split.

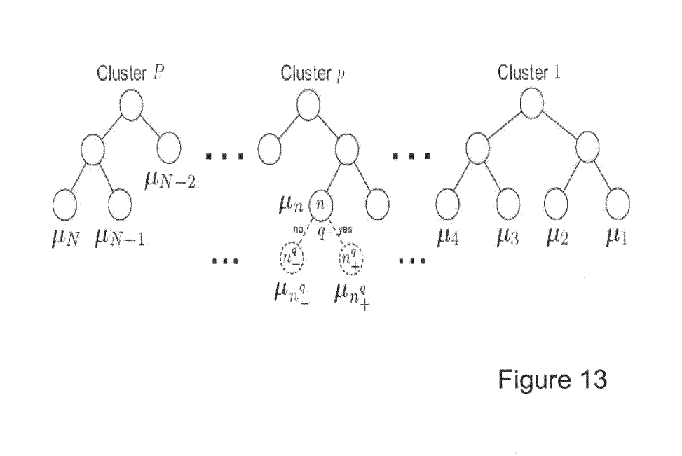

This process is shown for example in FIG. 13. The nth terminal node in a mean decision tree is divided into two new terminal nodes n₊^{q} and n₋^{q} by a question q. The likelihood gain achieved by this split can be calculated as follows:

$$ℒ ( n ) = - \frac{1}{2} {μ}_{n}^{T} ( {\sum }_{m ∈ S ( n )}^{ } {G}_{ii}^{( m )} ) {μ}_{n} + {μ}_{n}^{T} {\sum }_{m ∈ S ( n )}^{ } ( {k}_{i}^{( m )} - {\sum }_{j \neq i}^{ } {G}_{ij}^{( m )} {μ}_{c} ( m , j ) ) \qquad Eqn . 16$$

Where S(n) denotes a set of components associated with node n. Note that the terms which are constant with respect to μₙ are not included.

The maximum likelihood of μₙ is given by equation 10 Thus, the above can be written as:

$$ℒ ( n ) = \frac{1}{2} {\hat{μ}}_{n}^{T} ( {\sum }_{m ∈ S ( n )}^{ } {G}_{ii}^{( m )} ) {\hat{μ}}_{n} \qquad Eqn . 17$$

Thus, the likelihood gained by splitting node n into n₊^{q} and n₋^{q} is given by:

Δ [symbol] (n;q)= [symbol] (n₊^{q})+ [symbol] (n₋^{q})− [symbol] (n) Eqn. 18

Thus, using the above, it is possible to construct a decision tree for each cluster where the tree is arranged so that the optimal question is asked first in the tree and the decisions are arranged in hierarchical order according to the likelihood of splitting. A weighting is then applied to each cluster.

In a further embodiment, decision trees might be also constructed for variance. The covariance decision trees are constructed as follows: If the case terminal node in a covariance decision tree is divided into two new terminal nodes k₊^{q} and k₋^{q} by question q, the cluster covariance matrix and the gain by the split are expressed as follows:

$$\begin{matrix}{\sum }_{k}^{ } = \frac{{\sum }_{{m , t , s}_{v ( m ) = k}}^{ } {γ}_{m} ( t ) {{\sum }_{v ( m )}}_{ }^{ }}{{\sum }_{{m , t , s}_{v ( m ) = k}}^{ } {γ}_{m} ( t ) { }_{ }^{ }} & Eqn . 19 \\ ℒ ( k ) = - \frac{1}{2} {\sum }_{{m , t , s}_{v ( m ) = k}}^{ } {γ}_{m} ( t ) log \vert {{\sum }_{k}}_{ }^{ } \vert + D & Eqn . 20\end{matrix}$$

where D is constant independent of {Eₖ}. Therefore the increment in likelihood is

Δ [symbol] (k,q)= [symbol] (k₊^{q})+ [symbol] (k₋^{q})− [symbol] (k) Eqn. 21

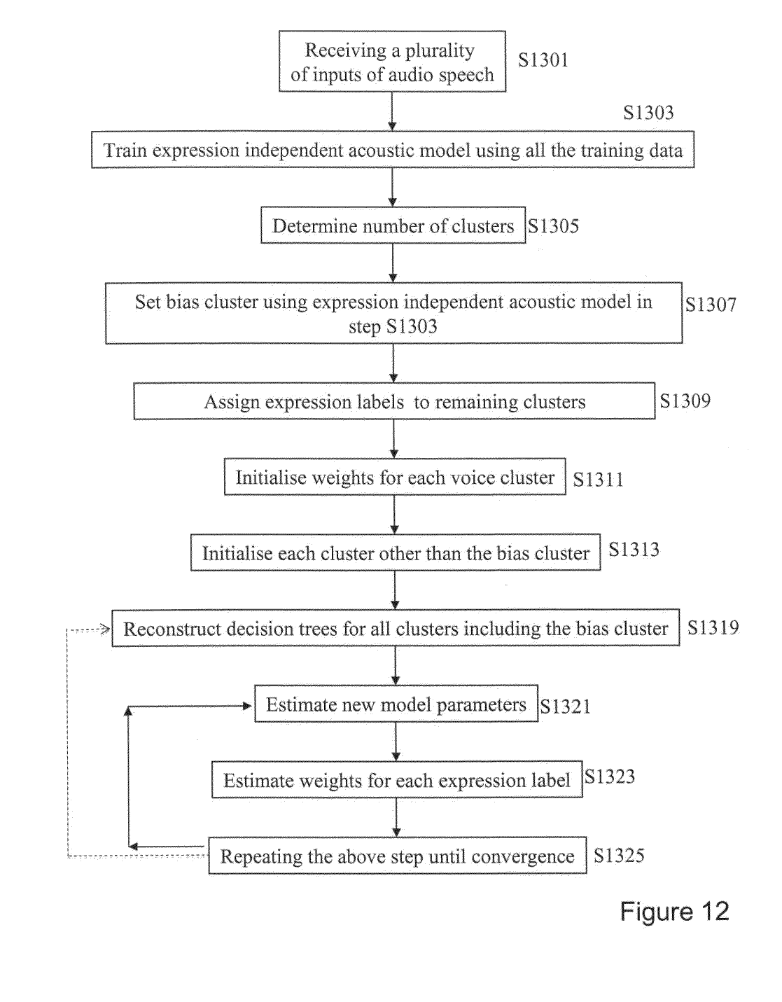

In a preferred embodiment, the process is performed in an iterative manner. This basic system is explained with reference to the flow diagram of FIG. 12.

In step S1301, a plurality of inputs of audio speech are received. In this illustrative example, 4 expressions are used.

Next, in step S1303, an expression independent acoustic model is trained using the training data with different expressions.

A cluster adaptive model is initialised and trained as follows:

In step S1305, the number of clusters P is set to V+1, where V is the number of different expressions for which data (4) is available.

In step S1307, one cluster (cluster 1), is determined as the bias cluster. The decision trees for the bias cluster and the associated cluster mean vectors are initialised using the voice which in step S1303 produced the expression independent model. The covariance matrices, space weights for multi-space probability distributions (MSD) and their parameter sharing structure are also initialised to those of the expression independent model.

In step S1309, a specific expression tag is assigned to each of 2, . . . , P clusters e.g. clusters 2, 3, 4, and 5 are for expressions A, B, C, D and respectively.

In step S311, a set of CAT interpolation weights are simply set to 1 or 0 according to the assigned expression tag as:

$${λ}_{i}^{( s )} = \{ \begin{matrix}1.0 & if i = 0 \\ 1.0 & if expression tag ( s ) = i \\ 0.0 & otherwise\end{matrix}$$

In this embodiment, there are global weights per expression, per stream. For each expression/stream combination 3 sets of weights are set: for silence, speech and pause.

In step S1313, for each cluster 2, . . . , (P−1) in turn the clusters are initialised as follows. The voice data for the associated voice, e.g. voice B for cluster 2, is aligned using the expression independent model trained in step S1303. Given these alignments, the statistics are computed and the decision tree and mean values for the cluster are estimated. The mean values for a given context are computed as the weighted sum of the cluster means using the weights set in step S1311 i.e. in practice this results in the mean values for a given context being the weighted sum (weight 1 in both cases) of the bias cluster mean for that context and the voice A model mean for that context in cluster 2.

Once the clusters have been initialised as above, the CAT model is then updated/trained as follows.

In step S1319 the decision trees are constructed cluster-by-cluster from cluster 1 to P, keeping the CAT weights fixed. In step S1321, new means and variances are estimated in the CAT model. Next in step S1323, new CAT weights are estimated for each cluster. In an embodiment, the process loops back to S321 until convergence. The parameters and weights are estimated using maximum likelihood calculations performed by using the auxiliary function of the Baum-Welch algorithm to obtain a better estimate of said parameters.

As previously described, the parameters are estimated via an iterative process.

In a further embodiment, at step S1323, the process loops back to step S1319 so that the decision trees are reconstructed during each iteration until convergence.

In addition, it is possible to optimise the CAT system using an expressive representation based on a utterance level point in a multi-dimensional continuous space. Here the process above can be repeated. However step s1323 is replaced by computing a point for each of the speech utterance, rather than each expression label. Again it is possible to iterate updating the model parameters, points in space (weights) and decision trees.

FIG. 13 shows clusters 1 to P which are in the forms of decision trees. In this simplified example, there are just four terminal nodes in cluster 1 and three terminal nodes in cluster P. It is important to note that the decision trees need not be symmetric i.e. each decision tree can have a different number of terminal nodes. The number of terminal nodes and the number of branches in the tree is determined purely by the log likelihood splitting which achieves the maximum split at the first decision and then the questions are asked in order of the question which causes the larger split. Once the split achieved is below a threshold, the splitting of a node terminates.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made without departing from the spirit of the inventions. The accompanying claims and their equivalents are intended to cover such forms of modifications as would fall within the scope and spirit of the inventions.

1. A text to speech method, the method comprising:
receiving input text;
dividing said inputted text into a sequence of acoustic units;
converting said sequence of acoustic units to a sequence of speech vectors using an acoustic model, wherein said model has a plurality of model parameters describing probability distributions which relate an acoustic unit to a speech vector; and
outputting said sequence of speech vectors as audio,
the method further comprising determining at least some of said model parameters by:
extracting expressive features from said input text to form an expressive linguistic feature vector constructed in a first space; and
mapping said expressive linguistic feature vector to an expressive synthesis feature vector which is constructed in a second space.

2. A method according to claim 1, wherein mapping the expressive linguistic feature vector to an expressive synthesis feature vector comprises using a machine learning algorithm.

3. A method according to claim 1, wherein said second space is a multi-dimensional continuous space.

4. A method according to claim 1, wherein extracting the expressive features from said input text comprises a plurality of extraction processes, said plurality of extraction processes being performed at different information levels of said text.

5. A method according to claim 4, wherein the different information levels are selected from a word based linguistic feature extraction level to generate word based linguistic feature vector, a full context phone based linguistic feature extraction level to generate full context phone based linguistic feature, a part of speech (POS) based linguistic feature extraction level to generate POS based feature and a narration style based linguistic feature extraction level to generate narration style information.

6. A method according to claim 4, wherein each of the plurality of extraction processes produces a feature vector, the method further comprising concatenating the linguistic feature vectors generated from the different information levels to produce a linguistic feature vector to map to the second space.

7. A method according to claim 4, wherein mapping the expressive linguistic feature vector to an expressive synthesis feature vector comprises a plurality of hierarchical stages corresponding to each of the different information levels.

8. A method according to claim 1, wherein the mapping uses full context information.

9. A method according to claim 1, wherein the acoustic model receives full context information from the input text and this information is combined with the model parameters derived from the expressive synthesis feature vector in the acoustic model.

10. A method according to claim 1, wherein the model parameters of said acoustic model are expressed as the weighted sum of model parameters of the same type and the weights are represented in the second space.

11. A method according to claim 10, wherein the said model parameters which are expressed as the weighted sum of model parameters of the same type are the means of Gaussians.

12. A method according to claim 10, wherein the parameters of the same type are clustered and the synthesis feature vector comprises a weight for each cluster.

13. A method according to claim 12, wherein each cluster comprises at least one decision tree, said decision tree being based on questions relating to at least one of linguistic, phonetic or prosodic differences.

14. A method according to claim 13, wherein there are differences in the structure between the decision trees of the clusters.

15. A method of training a text-to-speech system, the method comprising:
receiving training data, said training data comprising text data and speech data corresponding to the text data;
extracting expressive features from said input text to form an expressive linguistic feature vector constructed in a first space;
extracting expressive features from the speech data and forming an expressive feature synthesis vector constructed in a second space;
training a machine learning algorithm, the training input of the machine learning algorithm being an expressive linguistic feature vector and the training output the expressive feature synthesis vector which corresponds to the training input.

16. A method according to claim 15, further comprising outputting the expressive synthesis feature vector a speech synthesizer, said speech synthesizer comprising an acoustic model, wherein said model has a plurality of model parameters describing probability distributions which relate an acoustic unit to a speech vector.

17. A method according to claim 16, wherein the parameters of the acoustic model and the machine learning algorithm are jointly trained.

18. A method according to claim 16, wherein the model parameters of said acoustic model are expressed as the weighted sum of model parameters of the same type and the weights are represented in the second space and wherein the weights represented in the second space and the machine learning algorithm are jointly trained.

19. A text to speech apparatus, the apparatus comprising:
a receiver for receiving input text;
a processor adapted to:
divide said inputted text into a sequence of acoustic units; and
convert said sequence of acoustic units to a sequence of speech vectors using an acoustic model, wherein said model has a plurality of model parameters describing probability distributions which relate an acoustic unit to a speech vector; and
an audio output adapted to output said sequence of speech vectors as audio, the processor being further adapted to determine at least some of said model parameters by:
extracting expressive features from said input text to form an expressive linguistic feature vector constructed in a first space; and
mapping said expressive linguistic feature vector to an expressive synthesis feature vector which is constructed in a second space.

20. A carrier medium comprising computer readable code configured to cause a computer to perform the method of claim 1.
